(19) United States
(12) Patent Application Publication
(10) Pub. No.: US 2009/0180184 A1
(43) Pub. Date: Jul. 16, 2009

(54) Stable dielectric gratings implemented by composition striations in paraelectric crystals

(75) Inventors: Aharon J. Agranat, Mevasseret Zion (IL); Clovis Eduardo Mazzotti De Oliveira, Beer Sheva (IL)

Correspondence Address: MARTIN D. MOYNIHAN d/b/a PRTSI, INC., P.O. BOX 16446, ARLINGTON, VA, 22215, US

(73) Assignee: Koninklijke Phillips Electronics, N.V., Eindhoven (NL)

(21) Appl. No.: 10/566,264

(22) PCT Filed: Aug. 4, 2004
(86) PCT No.: PCT/IL04/00726

§ 371 Date: Apr. 17, 2007

Related U.S. Application Data
(60) Provisional application No. 60/491,996, filed on Aug. 4, 2003.

(51) Int. Cl. G02B 27/44; G02B 5/18

(52) U.S. Cl. 359/566

(57) ABSTRACT

Methods for permanently introducing patterns in electro-optic crystals are provided, by forming patterned variations in the composition of the electro-optic crystals [28], during the crystal growth process. These methods open a way to a family of light-controlling devices that can operate at temperatures as high as 80 degrees centigrade, and may be stored at temperatures as high as 300 degrees centigrade. Additionally, they may withstand radiation of natural light and cosmic ray. In accordance with one embodiment, an electrically [76] controlled Bragg grating is introduced into a crystal, by a permanent periodic spatial variation [60] of its composition, forming permanent periodic striations. The periodic striations induce a spatial modulation of the dielectric constant, and the application of a uniform electric field produces an induced polarization grating.

### FIELD AND BACKGROUND OF THE INVENTION

The present invention relates to electroholographic crystals, and in particular to electroholographic crystals in the paraelectric phase, in which electrically controlled Bragg gratings (ECBG) have been implemented by permanent periodic striations, produced during the crystal growth. [Electroholography (EH) is an optical switching method, based on electrical control of the reconstruction process of volume holograms. [A. J. Agranat, ‘Electroholographic Artificial Neural Networks’, Physika A 200, 608-612 (1993); M. Balberg, M. Razvag, S. Vidro, E. Refaelli, and A. J. Agranat, “Electroholographic neurons implemented on potassium lithium tantalate niobate crystals”, Opt. Lett. 21 (19), pp. 1544-1546 (1996) and B. Pesach, G. Bartal, E. Refaeli and A. J. Agranat, “Free Space Optical Cross-Connect Switch by Use of Electroholography.”, Applied Optics 39: (5) 746-758 (Feb. 10, 2000).]

It is particularly effective in wavelength division multiplexing (WDM) networks, where it is required to selectively manipulate single wavelength channels of WDM light waves. [A. J. Agranat, “Optical Lambda-Switching at Telecom Wavelengths Based on Electroholography”, in: IR Holography for Optical Communications—Techniques, Materials and Devices, Pierpaolo Boffi, Davide Piccinin, Maria Chiara Ubaldi (Eds.), (Springer Verlag series on Topics in Applied Physics 2002).]

FIGS. 1A and 1B illustrate a basic EH device 10, in which an electrically controlled Bragg grating (ECBG) 12 has been written. In the absence of an electric field, ECBG 12 is in a latent state, as seen in FIG. 1A, and is transparent to input beams, which propagate through it, unaffected. When the electric field is turned on, so that V=V₀, as seen in FIG. 1B, ECBG 12 is activated, and an input beam will be diffracted, provided it fulfills the Bragg condition. As seen in FIG. 1B, input beam λ₁, which fulfills Bragg's condition is diffracted, while input beam λ₂, which does not fulfill Bragg's condition is not. Thus, EH device 10 functions as a wavelength selective switch.

ECBGs are implemented by exploiting the voltage controlled photorefractive effect in paraelectric crystals. [A. J. Agranat, V. Leyva, and A. Yariv, ‘Voltage Controlled Photorefractive Effect in Paraelectric KTa₁₋ₓNbₓO₃: Cu,V′, Opt. Lett. 14, 1017 (1989); A. J. Agranat, R. Hofineister and A. Yariv, “Characterization of a New Photorefractive Material: Ki_{1-y} Li_{y}Ta₁₋ₓ NbₓO₃”, Optics Letters 17, 713 (1992).] Here the ECBG is implemented as a spatial distribution of space charge produced optically by the photorefractive process. A polarization grating induced by the space charge field is latent, namely, in the absence of an electric field, it is transparent to the reconstruction beam. An electric field applied to the crystal couples with the space charge grating and induces a birefringence grating through the quadratic electrooptic effect.

The reliability of ECBGs that are based on the voltage controlled photorefractive effect depends on the stability of the space charge grating. Yet, the latter is subject to two erasure mechanisms: erasure during readout and thermal erasure. Erasure during readout occurs when the space charge is illuminated by photons that photo-excite the trapped charges that constitute the space charge. These become mobile and travel in a direction that causes gradual erasure of the grating. Thermal erasure occurs by the thermalization of charges that are trapped in shallow traps and once they become mobile travel in a direction that causes gradual erasure of the grating. These two processes are the main mechanisms that govern lifetime of the ECBG both during operation and storage.

It is therefore desirable to produce electrically controlled Bragg gratings, which are immune to erasure mechanisms.

### SUMMARY OF THE INVENTION

The present invention successfully addresses the shortcomings of the presently known configurations by providing methods for permanently introducing patterns in electro-optic crystals, by forming patterned variations in the composition of the electro-optic crystals, during the crystal growth process. These methods open a way to a family of light-controlling devices that can operate at temperatures as high as 80 degrees centigrade, and may be stored at temperatures as high as 300 degrees centigrade. Additionally, they may withstand radiation of natural light and cosmic ray. In accordance with one embodiment, an electrically controlled Bragg grating (ECBG) is introduced into a crystal, by a permanent periodic spatial variation of its composition, forming permanent periodic striations. The periodic striations induce a spatial modulation of the dielectric constant, and the application of a uniform electric field produces an induced polarization grating. The latter induce an electrically controlled birefringence grating through the electrooptic effect. In accordance with another embodiment, the permanent periodic striations introduce permanent birefringence, which may be tuned and detuned with an application of an electric field. Additionally, other patterns, for example, striations of varying thickness, and (or) varying periodicity, or a single layer of a different composition may also be introduced into the crystal, for various applications.

According to one aspect of the present invention, there is provided an electroholographic switch, having:

an electro-optic crystal, in which an electrically controlled Bragg grating is stored, the electrically controlled Bragg grating being operable to deflect an incoming beam, which meets Bragg's condition for the grating, when an external electric field is applied to the crystal; and

a power supply, for providing the external electric field,

the improvement comprising permanently storing the electrically-controlled Bragg grating in the electro-optic crystal as periodic striations, produced as a concentration grating, during a growth process of the electro-optic crystal.

According to an additional aspect of the present invention, the electroholographic switch further includes a component of Bragg grating, operable in the absence of an electric field.

According to an additional aspect of the present invention, the electroholographic switch is operable at a temperature range of between about 10 and about 80 degrees centigrade.

According to an additional aspect of the present invention, the electroholographic switch is capable of withstanding storage temperature as high as 300 degrees centigrade.

According to an additional aspect of the present invention, the electroholographic switch further includes a temperature-control device, for maintaining the electro-optic crystal at a predetermined temperature.

According to an additional aspect of the present invention, the predetermined temperature is within ±3 degrees centigrade of a curie temperature of the electro-optic crystal.

According to an alternative aspect of the present invention, the predetermined temperature is between about 1 and about 5 degrees centigrade above of a curie temperature of the electro-optic crystal.

According to an alternative aspect of the present invention, the predetermined temperature is above of a curie temperature of the electro-optic crystal.

According to an additional aspect of the present invention, the concentration grating creates a grating in the phase transition temperature, T_{c}, which at the paraelectric phase, yields a grating in the dielectric constant.

According to an additional aspect of the present invention, the grating in the phase transition temperature, T_{c}, has an amplitude of between about 0.1 degrees and about 2 degrees K.

According to an additional aspect of the present invention, the concentration grating has a period spacing of between about 0.1 and about 20 μm.

According to an additional aspect of the present invention, the electro-optic crystal is KTN, and the concentration grating is formed by changes in concentration between niobium and tantalum.

According to an alternative aspect of the present invention, the electro-optic crystal is KLTN, and the concentration grating is formed by changes in concentration between niobium and tantalum.

According to an alternative aspect of the present invention, the electro-optic crystal is KLTN, and the concentration grating is formed by changes in concentration between lithium and potassium.

According to an alternative aspect of the present invention, the electro-optic crystal is KLTN, and the concentration grating is formed by changes in concentrations of niobium, lithium, and potassium.

According to an alternative aspect of the present invention, the electro-optic crystal is KNTN, and the concentration grating is formed by changes in concentration between sodium and potassium.

According to an alternative aspect of the present invention, the electro-optic crystal is KNTN, and the concentration grating is formed by changes in concentration between niobium and potassium.

According to an alternative aspect of the present invention, the electro-optic crystal is KNTN, and the concentration grating is formed by changes in concentrations of niobium, sodium, and potassium.

According to an alternative aspect of the present invention, the electro-optic crystal is SBN.

According to an alternative aspect of the present invention, the electro-optic crystal is BST.

According to an additional aspect of the present invention, the said external electric field is between 0 and 5 kV/cm.

According to an additional aspect of the present invention, the switch is operative as a wavelength-selective switch.

According to an alternative aspect of the present invention, the switch is operative as a selective switch for different angles of incidence.

According to another aspect of the present invention, there is provided a method of permanently storing an electrically-controlled Bragg grating in an electro-optic crystal, comprising:

determining a birefringence grating, for a particular application;

determining a concentration grating, which will yield the birefringence grating;

growing the electro-optic crystal at a periodic modulation in the growth temperature, to produce the concentration grating.

According to an additional aspect of the present invention, the method includes growing the electro-optic crystal at a cooling rate of between about −0.1 and about −1.0 degrees centigrade per hour.

According to an additional aspect of the present invention, the method includes producing the periodic modulation in the growth temperature by a periodic modulation of the cooling rate.

According to an additional aspect of the present invention, the method includes growing the electro-optic crystal at a pulling rate of between about 0.1 and about 1.5 mm per hour.

According to an additional aspect of the present invention, the method includes producing the periodic modulation in the growth temperature by a periodic modulation of the pulling rate.

According to an additional aspect of the present invention, the method includes blowing air on the electro-optic crystal, at an air-blowing rate of between about 2 and about 15 liters per minute.

According to an additional aspect of the present invention, the method includes producing the periodic modulation in the growth temperature by a periodic heating of the electro-optic crystal, using heating elements.

According to an additional aspect of the present invention, the method includes producing the periodic modulation in the growth temperature by stirring a growth solution.

According to an additional aspect of the present invention, the method includes cyclically changing the direction of the stirring.

According to an additional aspect of the present invention, the method includes producing the periodic modulation in the growth temperature by rotating a growth crucible, when at a center position.

According to an additional aspect of the present invention, the method includes cyclically changing the direction of the rotating.

According to an additional aspect of the present invention, the method includes producing the periodic modulation in the growth temperature by rotating a growth crucible, when at an off-center position.

According to an additional aspect of the present invention, the method includes producing the periodic modulation in the growth temperature by rotating the crystal, when at a center position.

According to an additional aspect of the present invention, the method includes cyclically changing the direction of the rotating.

According to an additional aspect of the present invention, the method includes producing the periodic modulation in the growth temperature by rotating the electro-optic crystal, when at an off-center position.

According to an additional aspect of the present invention, the periodic modulation in the growth temperature is varied between every 10 and every 30 seconds.

According to an additional aspect of the present invention, the periodic modulation in the growth temperature is varied between every 10 and every 300 seconds.

According to an additional aspect of the present invention, the periodic modulation in the growth temperature further including a pause of between 1 and 15 seconds between modulation cycles.

According to still another aspect of the present invention, there is provided an electroholographic switch, having:

an electro-optic crystal, in which a Bragg grating is stored as periodic striations, produced as a concentration grating during the growth process of the electro-optic crystal; and

a power supply, in communication with the crystal, for providing an external electric field, to selectively detune the Bragg grating.

According to yet another aspect of the present invention, there is provided an electroholographic switch, having:

an electro-optic crystal, in which a Bragg grating is stored as periodic striations, produced as a concentration grating during the crystal-growth process of the electro-optic crystal; and

a power supply, in communication with the crystal, for providing an external electric field, to selectively tune the Bragg grating.

According to still another aspect of the present invention, there is provided a method of permanently storing an electrically-controlled Bragg grating in an electro-optic crystal, comprising:

determining a concentration pattern, for a particular application; growing the electro-optic crystal at a periodic modulation in the growth temperature, to produce the concentration pattern.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1B schematically illustrates a basic electro-optic device, as known;

FIG. 2 schematically illustrates a system for a top-seeded-solution growth method, in accordance with the present invention;

FIGS. 3A and 3B schematically illustrate systems for top-seeded-solution growth methods at center and off-center positions, in accordance with the present invention;

FIG. 4 schematically illustrates a periodic modulation in the growth temperature, to produce a concentration grating, in accordance with the present invention;

FIG. 5 schematically illustrates the effect of a periodic modulation in the growth temperature on a phase diagram, in accordance with the present invention;

FIGS. 6A and 6B illustrate experimental results of striation grating grown in a crystal, in accordance with the present invention;

FIGS. 7A and 7B illustrate experimental results of diffraction efficiency of an electro-optic device of the present invention; and

FIGS. 8A and 8B schematically illustrate an electroholographic switch, in accordance with the present invention.

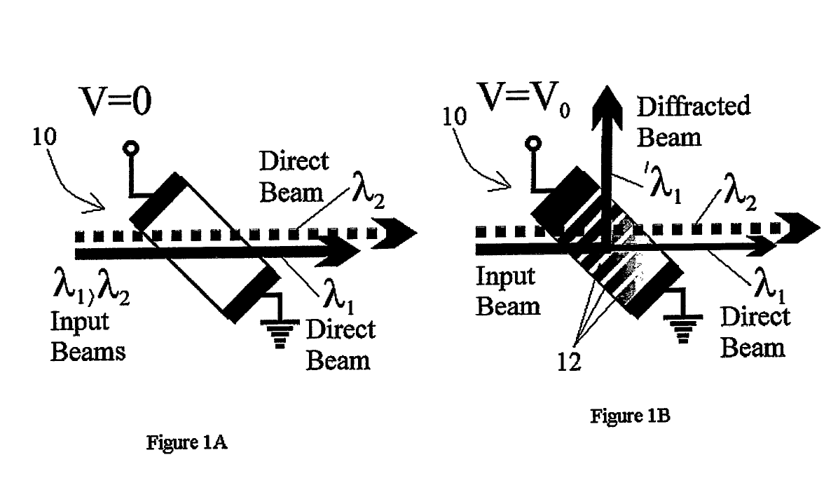

### DESCRIPTION OF THE PREFERRED EMBODIMENTS

The present invention relates to methods for permanently introducing patterns in electro-optic crystals, by forming patterned variations in the composition of the electro-optic crystals, during the crystal growth process. These methods open a way to a family of light-controlling devices that can operate at temperatures as high as 80 degrees centigrade, and may be stored at temperatures as high as 300 degrees centigrade. Additionally, they may withstand radiation of natural light and cosmic ray. In accordance with one embodiment, an electrically controlled Bragg grating (ECBG) is introduced into a crystal, by a permanent periodic spatial variation of its composition, forming permanent periodic striations. The periodic striations induce a spatial modulation of the dielectric constant, and the application of a uniform electric field produces an induced polarization grating. The latter induce an electrically controlled birefringence grating through the electrooptic effect. In accordance with another embodiment, the permanent periodic striations introduce permanent birefringence, which may be tuned and detuned with an application of an electric field. Additionally, other patterns, for example, striations of varying thickness, and (or) varying periodicity, or a single layer of a different composition may also be introduced into the crystal, for various applications.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

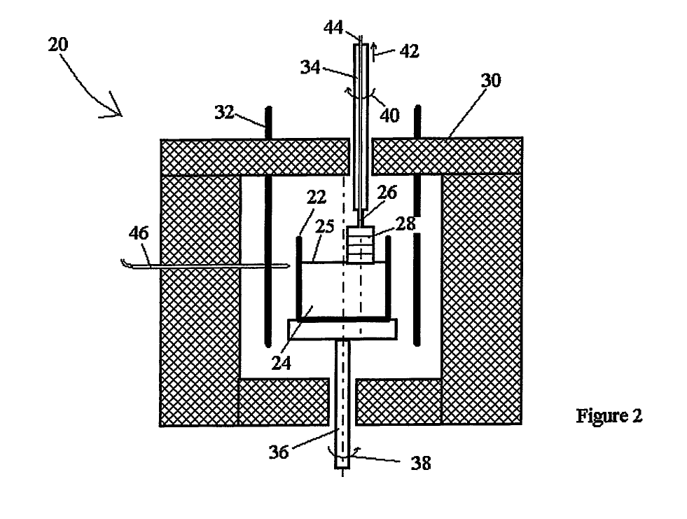

Referring now to the drawings, FIG. 2 schematically illustrates a system 20 for a top-seeded-solution growth method, in accordance with the present invention.

System 20 includes a crucible 22 containing a solution 24. For example, for KTN, KNTN, or KLTN, solution 24 may be potassium oxide as solvent and the others components are solutes. A cooled seed 26 is immersed in solution 24, and system 20 is cooled down slowly, as a crystal 28 grows on an interface 25 between the seed and the solution.

A rod 34 is used to pull crystal 28, as shown in the direction of an arrow 42.

System 20 may further include thermal insulation 30, at least one, and possibly several heaters 32, for heating crucible 22, and at least one, and possibly several temperature probes 46, for monitoring the temperature of system 20.

Additionally, air blowing for cooling may be performed on crystal 28, for example, via an internal tube 44 in rod 34.

Furthermore, rod 34 and crystal 28 may be rotated, for example, in a direction of an arrow 40, to stir and homogenize solution 24.

Moreover, crucible 22 may be rotated, for example, in a direction of an arrow 38, to stir and homogenize solution 24.

A detailed description of this method may be found in R. Hofineister, S. Yagi, A. Yariv, and A. J. Agranat, ‘Growth and Characterization of KLTN:Cu,V Photorefractive Crystals’, J. Cryst. Growth 131, pp 486-494 (1993), whose disclosure is incorporated herein by reference.

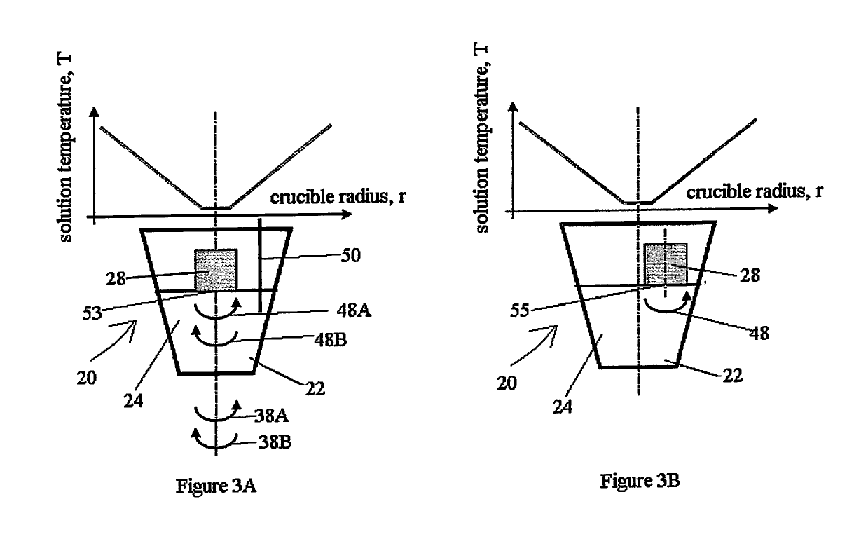

Referring further to the drawings, FIGS. 3A and 3B schematically illustrate systems for top-seeded-solution growth methods at center and off-center positions, in accordance with the present invention.

As seen in FIG. 3A, crucible 22 is in a center position 53, so as to experience a substantially uniform temperature.

As seen in FIG. 3B, crucible 22 is in at an off-center position 55, so as to experience a temperature gradient. In accordance with the present invention, the temperature gradient may be between about 1 and about 6 degrees centigrade per cm, and preferably about 3 degrees centigrade per cm.

In accordance with the present invention, FIGS. 2, 3A, and 3B illustrate several features for producing changes the growth temperature, in order to form patterned variations in the composition of the electro-optic crystals, during the crystal growth process.

This may include any of the following:

1. variation in the cooling rate of system 20;
2. variation in the pulling rate of crystal 28;
3. cyclic heating of system 20, via heaters 32;
4. stirring solution 24, via a rod 50;
5. stirring solution 24, via a rod 50, and cyclically changing the direction of stirring;
6. rotating crucible 22, when at a center position, for example, in the direction of an arrow 38A;
7. rotating crucible 22, when at center position, and cyclically changing the direction of rotation, between arrows 38A and 38B;
8. rotating crystal 28, when at a center position, for example, in the direction of an arrow 48A;
9. rotating crystal 28, when at a center position, and cyclically changing the direction of rotation, for example, in the directions of arrow 48A and 48B;
10. rotating crystal 28, when at an off-center position, for example, in the direction of an arrow 48.

It will be appreciated that a combination of these, as well as other methods and combinations with other methods are similarly possible.

Preferably, a periodic modulation of as low as about 10 and about 15 seconds may be achieved. It will be appreciated that longer periods, for example, as high as 300 seconds are similarly possible.

It will be appreciated that a pause of about 1-5 seconds may be exercised between periods.

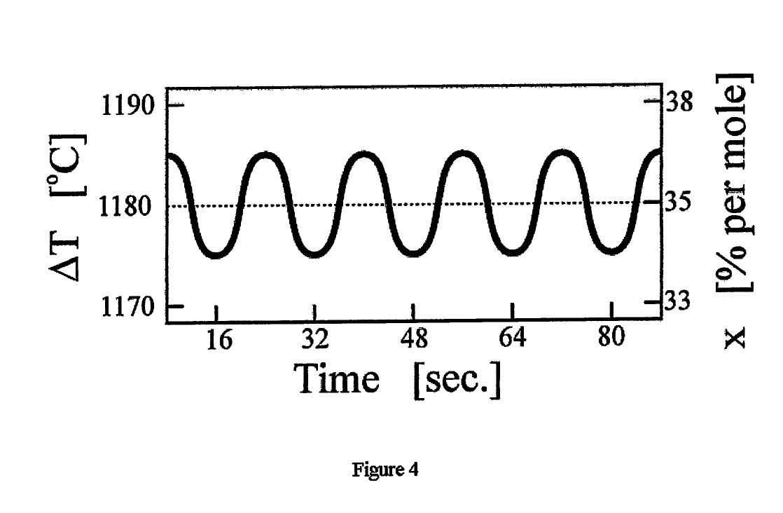

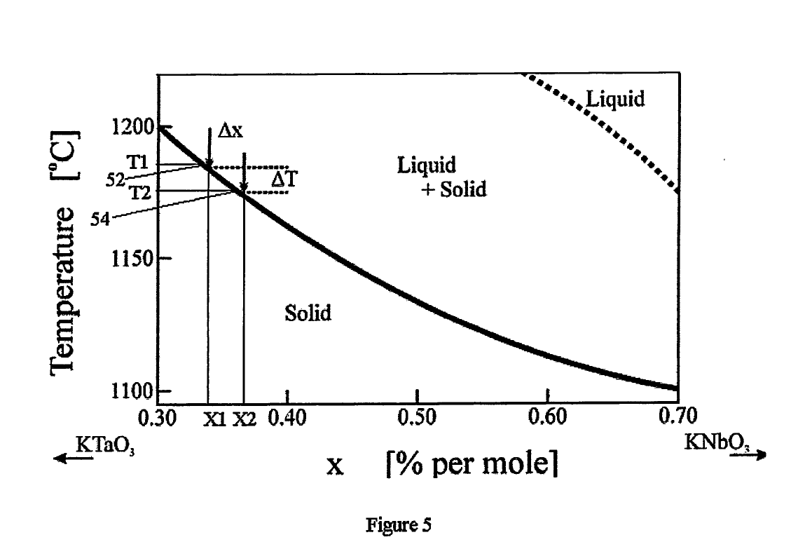

Referring further to the drawings, FIG. 4 schematically illustrates a periodic modulation in the growth temperature, as produced by a method as illustrated hereinabove, in conjunction with FIGS. 2-3B, for producing a concentration grating, in accordance with the present invention. Additionally, FIG. 5 schematically illustrates the effect of a periodic modulation in the growth temperature on a phase diagram, in accordance with the present invention.

As FIGS. 4 and 5 illustrate, a change in the growth temperature between points T1 and T2, will result in crystallization along the line connecting points 52 and 54, leading to a change the concentration between points X1 and X2.

Where cyclic cooling and heating is experienced, crystallization occurs along points 52, 54, 52, 54, . . . so as to result in a periodic structure. It will be appreciated that other structures may similarly be realized. For example, if only one period of cooling and heating is experienced, a single layer of a different concentration may be produced.

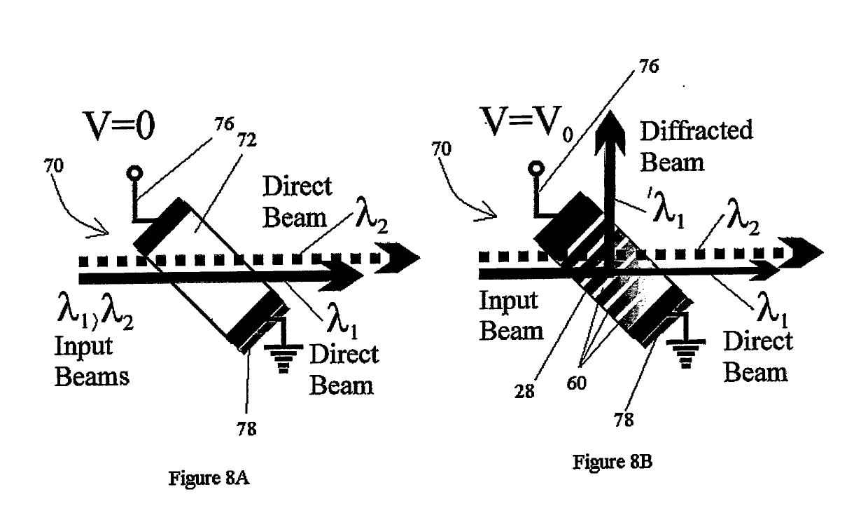

Referring further to the drawings, FIGS. 8A and 8B schematically illustrate an electroholographic switch 70 in accordance with the present invention. Preferably, electroholographic switch 70 includes:

an electro-optic crystal 28, in which an electrically controlled Bragg grating 60 is stored, the electrically controlled Bragg grating being operable to deflect an incoming beam, which meets Bragg's condition for the grating, when an external electric field, V, is applied to the crystal; and

a power supply 76, for providing the external electric field, which is preferably between 0 and 5 kV/cm.

Additionally, a temperature control device 78 may be added, for maintaining a stable operating temperature.

It will be appreciated that electroholographic switch 70 may operate in the paraelectric phase, wherein the periodic striations induce a spatial modulation of the dielectric constant, and the application of a uniform electric field produces an induced polarization grating. The latter induces an electrically controlled birefringence grating through the electrooptic effect.

Alternatively, electroholographic switch 70 may operate in the ferroelectric phase, by Bragg detuning.

According to an aspect of the present invention, the electroholographic switch is operable at a temperature range of between about 10 and about 80 degrees centigrade.

According to an additional aspect of the present invention, the electroholographic switch is capable of withstanding storage temperature as high as 300 degrees centigrade.

According to an additional aspect of the present invention, the electroholographic switch further includes a temperature-control device, for maintaining the electro-optic crystal at a predetermined temperature.

According to an additional aspect of the present invention, the predetermined temperature is within ±3 degrees centigrade of a curie temperature of the electro-optic crystal.

According to an alternative aspect of the present invention, the predetermined temperature is between about 1 and about 5 degrees centigrade above of a curie temperature of the electro-optic crystal.

According to an alternative aspect of the present invention, the predetermined temperature is above of a curie temperature of the electro-optic crystal.

According to an additional aspect of the present invention, the concentration grating creates a grating in the phase transition temperature, T_{c}, which at the paraelectric phase, yields a grating in the dielectric constant.

According to an additional aspect of the present invention, the grating in the phase transition temperature, T_{c}, has an amplitude of between about 0.1 degrees and about 2 degrees K.

According to an additional aspect of the present invention, the concentration grating has a period spacing of between about 0.1 and about 20 μm.

According to an additional aspect of the present invention, the electro-optic crystal is KTN, and the concentration grating is formed by changes in concentration between niobium and tantalum.

According to an alternative aspect of the present invention, the electro-optic crystal is KLTN, and the concentration grating is formed by changes in concentration between niobium and tantalum.

According to an alternative aspect of the present invention, the electro-optic crystal is KLTN, and the concentration grating is formed by changes in concentration between lithium and potassium.

According to an alternative aspect of the present invention, the electro-optic crystal is KLTN, and the concentration grating is formed by changes in concentrations of niobium, lithium, and potassium.

According to an alternative aspect of the present invention, the electro-optic crystal is KNTN, and the concentration grating is formed by changes in concentration between sodium and potassium.

According to an alternative aspect of the present invention, the electro-optic crystal is KNTN, and the concentration grating is formed by changes in concentration between niobium and potassium.

According to an alternative aspect of the present invention, the electro-optic crystal is KNTN, and the concentration grating is formed by changes in concentrations of niobium, sodium, and potassium.

According to an alternative aspect of the present invention, the electro-optic crystal is SBN.

According to an alternative aspect of the present invention, the electro-optic crystal is BST.

According to an additional aspect of the present invention, the external electric field is between 0 and 5 kV/cm.

According to an additional aspect of the present invention, the switch is operative as a wavelength-selective switch.

According to an alternative aspect of the present invention, the switch is operative as a selective switch for different angles of incidence.

According to one aspect of the present invention, there is provided a method of permanently storing an electrically-controlled Bragg grating in an electro-optic crystal, comprising:

determining a birefringence grating, for a particular application;

determining a concentration grating, which will yield the birefringence grating;

growing the electro-optic crystal at a periodic modulation in the growth temperature, to produce the concentration grating.

According to an additional aspect of the present invention, the method includes growing the electro-optic crystal at a cooling rate of between about −0.1 and about −1.0 degrees centigrade per hour.

According to an additional aspect of the present invention, the method includes producing the periodic modulation in the growth temperature by a periodic modulation of the cooling rate.

According to an additional aspect of the present invention, the method includes growing the electro-optic crystal at a pulling rate of between about 0.1 and about 1.5 mm per hour.

According to an additional aspect of the present invention, the method includes producing the periodic modulation in the growth temperature by a periodic modulation of the pulling rate.

According to an additional aspect of the present invention, the method includes blowing air on the electro-optic crystal, at an air-blowing rate of between about 2 and about 15 liters per minute.

According to an additional aspect of the present invention, the method includes producing the periodic modulation in the growth temperature by a periodic heating of the electro-optic crystal, using heating elements.

According to an additional aspect of the present invention, the method includes producing the periodic modulation in the growth temperature by stirring a growth solution.

According to an additional aspect of the present invention, the method includes cyclically changing the direction of the stirring.

According to an additional aspect of the present invention, the method includes producing the periodic modulation in the growth temperature by rotating a growth crucible, when at a center position.

According to an additional aspect of the present invention, the method includes cyclically changing the direction of the rotating.

According to an additional aspect of the present invention, the method includes producing the periodic modulation in the growth temperature by rotating a growth crucible, when at an off-center position.

According to an additional aspect of the present invention, the method includes producing the periodic modulation in the growth temperature by rotating the crystal, when at a center position.

According to an additional aspect of the present invention, the method includes cyclically changing the direction of the rotating.

According to an additional aspect of the present invention, the method includes producing the periodic modulation in the growth temperature by rotating the electro-optic crystal, when at an off-center position.

According to an additional aspect of the present invention, the periodic modulation in the growth temperature is varied between every 10 and every 30 seconds.

According to an additional aspect of the present invention, the periodic modulation in the growth temperature is varied between every 10 and every 300 seconds.

According to an additional aspect of the present invention, the periodic modulation in the growth temperature further including a pause of between 1 and 15 seconds between modulation cycles.

According to an alternative aspect of the present invention, there is provided an electroholographic switch, having:

an electro-optic crystal, in which a Bragg grating is stored as periodic striations, produced as a concentration grating during the growth process of the electro-optic crystal; and

a power supply, in communication with the crystal, for providing an external electric field, to selectively detune the Bragg grating.

According to still another aspect of the present invention, there is provided an electroholographic switch, having:

an electro-optic crystal, in which a Bragg grating is stored as periodic striations, produced as a concentration grating during the crystal-growth process of the electro-optic crystal; and

a power supply, in communication with the crystal, for providing an external electric field, to selectively tune the Bragg grating.

According to yet another aspect of the present invention, there is provided a method of permanently storing an electrically-controlled Bragg grating in an electro-optic crystal, comprising:

determining a concentration pattern, for a particular application; growing the electro-optic crystal at a periodic modulation in the growth temperature, to produce the concentration pattern.

### Theoretical Basis of the Dielectric ECBG

It is well established that the ferroelectric phase transition temperature T_{c} is strongly affected by the presence of impurities and defects. For example, the replacement of a Ta⁺⁵ ion in potassium tantalate niobate (KTN) by an Nb⁺⁵ ion will cause a change in T_{c} of magnitude: δT_{c}=7.5 K/1% per mole Nb⁺⁵ [C. H. Perry in Light Scattering in Solids”, M. Balkanski (Eds.)]. A similar effect can be achieved by replacing a K⁺ ion in KTN by either Li⁺ or Na⁺.

Consider a KTN crystal in which a periodic grating in the concentration of the niobium was generated during the growth of the crystal so that the relative concentration of the niobium ions is given by

$$\frac{[ {Nb}^{+ 5} ]}{[ {Nb}^{+ 5} ] + [ {Ta}^{+ 5} ]} = A \cdot cos ( K \cdot x ) \qquad [ 1 ]$$

where K is the grating vector of the relative concentration and A is its amplitude. This concentration grating will create spatially correlated variations in the phase transition temperature that will result in a T_{c} grating given by

δT_{c}(x)=ΔT_{c} cos(K·x) [2]

where ΔT_{c} is the amplitude of the T_{c} grating. At the paraelectric phase, according to the Curie Weiss law, the T_{c} grating will yield a dielectric grating with spatial dependence given by

$${δɛ}_{r} ( x ) = \frac{- C}{{( T - {T}_{c} )}^{2}} \cdot Δ {T}_{c} cos ( K \cdot x ) \qquad [ 3 ]$$

where C is the Curie constant and ∈ᵣ is the relative (low frequency) dielectric constant. Applying a uniform electric field to the crystal will generate an induced polarization grating that is spatially correlated with the δ∈ᵣ grating and is given by

δP(X)=∈₀δ∈ᵣ(X)E₀ [4]

where ∈₀ is the dielectric permittivity. (It is assumed in [4] that the crystal is slightly above T_{c} so that ∈ᵣ>>1).

In general, at the paraelectric phase where the electrooptic effect is quadratic, the electric field induced birefringence is given by

Δn=−(1/2)n₀³g_{eff.}P² [5]

where no is the index of refraction at the paraelectric phase, g_{eff.} is the effective quadratic electrooptic coefficient, and P is the induced (static, or low frequency) polarization.

Thus, the application of a uniform electric field to a crystal containing a T_{c} grating will result in an ECBG of the form

$$δ [ Δ n ] ( x ) = - \frac{{n}_{0}^{3} {g}_{eff .} {ɛ}_{0}^{2} {ɛ}_{r}^{2}}{T - {T}_{c}} {E}_{0}^{2} \cdot Δ {T}_{c} cos ( K \cdot x ) \qquad [ 6 ]$$

where E₀ is the applied electric field.

As an example, consider a KLTN crystal in which a T_{c} grating with a period spacing of 1 μm and amplitude of ΔT_{c}=1K was formed during the growth of the crystal. Assume a 3 mm thick sample is set in the configuration presented in FIG. 2 in which the grating vector, the applied electric field, and the polarization of the input beam are parallel. For this configuration g_{eff.}=0.1 m⁴/C². Setting the crystal at T-T_{c}=5° C., and assuming ∈ᵣ=10⁴ and E₀=3.0 kV/cm, will yield (according to [6]) a birefringence grating given by

δ(Δn)=2.92·10⁻⁴ [7]

It should be noted that alternatively the T_{c} grating can be generated by either the formation of [Li₊]/[K⁺] concentration grating, or by formation of a [Na⁺]/[K⁺] concentration grating.

### EXAMPLES

Reference is now made to the following examples, which together with the above description illustrate the invention in a non-limiting fashion.

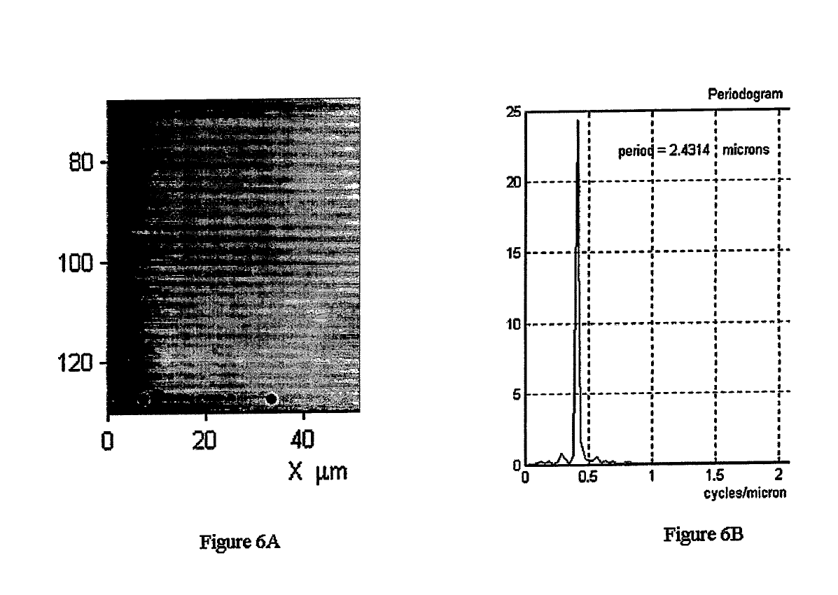

Referring further to the drawings, FIGS. 6A and 6B illustrate experimental results of a striation grating grown in a crystal, in accordance with the present invention.

Method 10, rotating crystal 28, when at an off-center position, was used to produce striations with periods ranging from 0.2 to 10 microns. FIG. 6A illustrates a period of approximately 0.5 microns. FIG. 6B illustrates a Fourier transform of the interference pattern of the crystal in FIG. 6A.

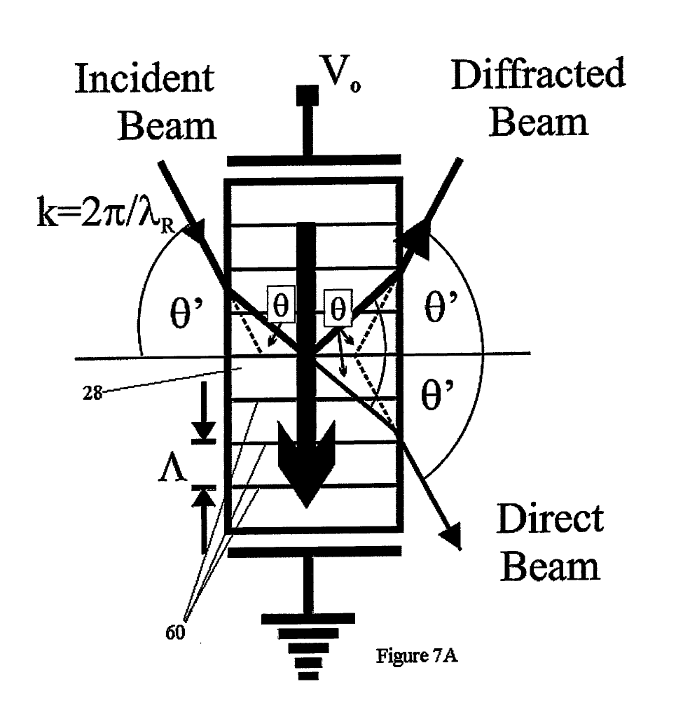

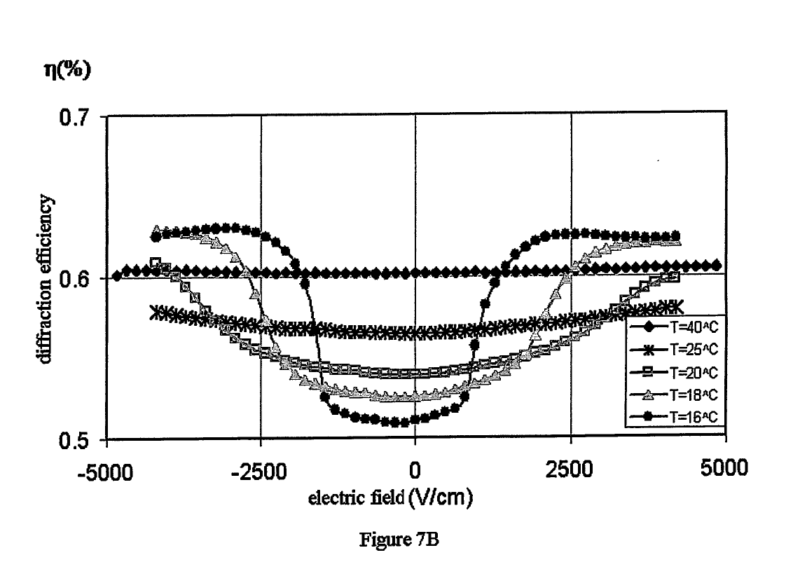

Referring further to the drawings, FIGS. 7A and 7B illustrate experimental results of a diffraction efficiency of an electro-optic device of the present invention.

Method 9, rotating crystal 28, when at a center position, and cyclically changing the direction of rotation, was used with KLTN crystal 28, to produce a striation grating 60. The crystal phase transition temperature was T_{c}=18 degrees centigrade, and the grating period was approximately Λ=10.2 μm. The diffraction was measured in the configuration illustrated in FIG. 7A. A probe beam at λ_{R}=1.31 μm was directed at the sample at θ′=7.5° to its input surface, so that it was Bragg matched to the second harmonic of the grating. The beam crossed approximately 90 periods of the grating. Measured diffraction efficiencies as functions of the applied electric fields are presented in FIG. 7B for a series of operating temperatures.

A Good on/off feature of diffraction efficiency with applied electric field is achieved at temperatures of between about 16 and about 18 degrees centigrade, while above 25 degrees centigrade, and in particular, at 40 degrees centigrade, the diffraction efficiency seems insensitive to the electric filed. Thus, the crystal may generate a strong diffraction also at E₀=0, at temperatures above 25 degrees centigrade.

It is expected that during the life of this patent many relevant methods for permanently introducing patterns in electro-optic crystals may be developed and the scope of the present invention is intended to include all such new technologies a priori.

As used herein the term “about” refers to ±20%.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An electroholographic switch, having:
an electro-optic crystal, in which an electrically controlled Bragg grating is stored, said electrically controlled Bragg grating being operable to deflect an incoming beam, which meets Bragg's condition for said grating, when an external electric field is applied to said crystal; and
a power supply, for providing said external electric field,
the improvement comprising permanently storing said electrically-controlled Bragg grating in said electro-optic crystal as periodic striations, produced as a concentration grating, during a growth process of said electro-optic crystal.

2. The electroholographic switch of claim 1, and further including a component of Bragg grating, operable in the absence of an electric field.

3. The electroholographic switch of claim 1, operable at a temperature range of between about 10 and about 80 degrees centigrade.

4. The electroholographic switch of claim 1, capable of withstanding storage temperature as high as 300 degrees centigrade.

5. The electroholographic switch of claim 1, and further including a temperature-control device, for maintaining said electro-optic crystal at a predetermined temperature.

6. The electroholographic switch of claim 5, wherein said predetermined temperature is within ±3 degrees centigrade of a curie temperature of said electro-optic crystal.

7. The electroholographic switch of claim 5, wherein said predetermined temperature is between about 1 and about 5 degrees centigrade above of a curie temperature of said electro-optic crystal.

8. The electroholographic switch of claim 5, wherein said predetermined temperature is above of the Curie temperature of said electro-optic crystal.

9. The electroholographic switch of claim 1, wherein said concentration grating creates a grating in the phase transition temperature, T_{c}, which at the paraelectric phase, yields a grating in the dielectric constant.

10. The electroholographic switch of claim 9, wherein said grating in the phase transition temperature, T_{c}, has an amplitude of between about 0.1 degrees and about 2 degrees K.

11. The switch of claim 1, wherein said concentration grating has a period spacing of between about 0.1 and about 20 μm.

12. The electroholographic switch of claim 1, wherein said electro-optic crystal is KTN, and said concentration grating is formed by changes in concentration between niobium and tantalum.

13. The electroholographic switch of claim 1, wherein said electro-optic crystal is KLTN, and said concentration grating is formed by changes in concentration between niobium and tantalum.

14. The electroholographic switch of claim 1, wherein said electro-optic crystal is KLTN, and said concentration grating is formed by changes in concentration between lithium and potassium.

15. The electroholographic switch of claim 1, wherein said electro-optic crystal is KLTN, and said concentration grating is formed by changes in concentrations of niobium, lithium, and potassium.

16. The electroholographic switch of claim 1, wherein said electro-optic crystal is KNTN, and said concentration grating is formed by changes in concentration between sodium and potassium.

17. The electroholographic switch of claim 1, wherein said electro-optic crystal is KNTN, and said concentration grating is formed by changes in concentration between niobium and potassium.

18. The electroholographic switch of claim 1, wherein said electro-optic crystal is KNTN, and said concentration grating is formed by changes in concentrations of niobium, sodium, and potassium.

19. The electroholographic switch of claim 1, wherein said electro-optic crystal is selected from the group consisting of SBN and BST.

20. The electroholographic switch of claim 1, wherein said external electric field is 0 and 5 kV/cm.

21. The electroholographic switch of claim 1, selected from the group consisting of a wavelength selection switch and a switch for different angles of incidence.

22. An electroholographic switch, having:
an electro-optic crystal, in which a Bragg grating is stored as periodic striations, produced as a concentration grating during the growth process of said electro-optic crystal; and
a power supply, in communication with said crystal, for providing an external electric field, to selectively detune said Bragg grating.

23. An electroholographic switch, having:
an electro-optic crystal, in which a Bragg grating is stored as periodic striations, produced as a concentration grating during the crystal-growth process of said electro-optic crystal; and
a power supply, in communication with said crystal, for providing an external electric field, to selectively tune said Bragg grating.

24. A method of permanently storing an electrically-controlled Bragg grating in an electro-optic crystal, comprising:
determining a birefringence grating, for a particular application;
determining a concentration grating, which will yield said birefringence grating;
growing said electro-optic crystal at a periodic modulation in the growth temperature, to produce said concentration grating.

25. The method of claim 24, and further including growing said electro-optic crystal at a cooling rate of between about −0.1 and about −1.0 degrees centigrade per hour.

26. The method of claim 25, wherein said periodic modulation in the growth temperature is produced by a periodic modulation of said cooling rate.

27. The method of claim 24, and further including growing said electro-optic crystal at a pulling rate of between about 0.1 and about 1.5 mm per hour.

28. The method of claim 27, wherein said periodic modulation in the growth temperature is produced by a periodic modulation of said pulling rate.

29. The method of claim 24, wherein said periodic modulation in the growth temperature is produced by a periodic heating of said electro-optic crystal, using heating elements.

30. The method of claim 24, wherein said periodic modulation in the growth temperature is produced by stirring a growth solution.

31. The method of claim 30, and further including cyclically changing the direction of said stirring.

32. The method of claim 24, wherein said periodic modulation in the growth temperature is produced by rotating a growth crucible, when at a center position.

33. The method of claim 32, and further including cyclically changing the direction of said rotating.

34. The method of claim 24, wherein said periodic modulation in the growth temperature is produced by rotating a growth crucible, when at an off-center position.

35. The method of claim 24, wherein said periodic modulation in the growth temperature is produced by rotating said crystal, when at a center position.

36. The method of claim 35, and further including cyclically changing the direction of said rotating.

37. The method of claim 24, wherein said periodic modulation in the growth temperature is produced by rotating said electro-optic crystal, when at an off-center position.

38. The method of claim 24, wherein said periodic modulation in the growth temperature is varied between every 10 and every 30 seconds.

39. The method of claim 24, wherein said periodic modulation in the growth temperature is varied between every 10 and every 300 seconds.

40. The method of claim 24, wherein said periodic modulation in the growth temperature further including a pause of between 1 and 15 seconds between modulation cycles.

41. A method of permanently storing an electrically-controlled Bragg grating in an electro-optic crystal, comprising:
determining a concentration pattern, for a particular application;
growing said electro-optic crystal at a periodic modulation in the growth temperature, to produce said concentration pattern.
